(19) United States
(12) Patent Application Publication
(10) Pub. No.: US 2006/0099944 A1
(43) Pub. Date: May 11, 2006

(54) Method and system for providing mobile vehicle sales recommendations

(75) Inventors: Steven J. Ross, Livonia, MI (US); Nathan D. Ampunan, West Bloomfield, MI (US); Jeffrey G. Ravas, Oxford, MI (US); Jeffrey M. Stefan, Clawson, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/983,793

(22) Filed: Nov. 8, 2004

(51) Int. Cl. H04Q 7/20

(52) U.S. Cl. 455/432.3

(57) ABSTRACT

A method and system for providing mobile vehicle sales recommendations. Vehicle usage data for at least one mobile vehicle is received at a call center, at least one vehicle usage profile is created based on the received vehicle usage data, a vehicle profile request is received at the call center from a sales center, and the vehicle usage profile is sent from the call center to the sales center based on the received vehicle profile request. A computer usable medium with suitable computer program code is employed for providing mobile vehicle sales recommendations.

### FIELD OF THE INVENTION

This invention relates generally to vehicle data collection. In particular the invention relates to providing mobile vehicle sales recommendations.

### BACKGROUND OF THE INVENTION

Mobile vehicle sales recommendations based on a customer's usage of their current vehicle can streamline the sales process and provide added value to the customer. Limited information relating to a customer's use of their current vehicle is available to a vehicle sales representative. These sales representatives attempt to ascertain from a customer the needs of their lifestyle in order to recommend an appropriate vehicle. Access to this information is limited to that which is obtained through an interview with the customer and that which is available from the vehicle itself if it is traded in or turned in at the end of a lease term.

A service facility can also collect information regarding the customer's vehicle but a customer may not always use the same facility and access to that data is not commonly available to persons other than those that are employed by the service facility. Vehicle information that is collected during a customer's term of ownership can provide an accurate picture of how a customer uses the vehicle. Currently no repository exists to collect this information and make it available to the customer or to a sales representative when needed. Also, no means exists for a customer or sales representative to request historical vehicle information from a sales center.

A limited number of vehicles are equipped to send and receive data relating to vehicle usage to some type of central repository. In addition, the data must be formatted and delivered in a form that makes it useful for the end user.

It is therefore desirable to provide a method and system for communications between a telematics call center and a telematics unit that overcomes the limitations, challenges, and obstacles described above.

### SUMMARY OF THE INVENTION

One aspect of the present invention provides a method for providing mobile vehicle sales recommendations. The method comprises receiving vehicle usage data for at least one mobile vehicle at a call center, creating at least one vehicle usage profile based on the received vehicle usage data, receiving a vehicle profile request at the call center from a sales center, and sending the vehicle usage profile based on the received vehicle profile request from the call center to the sales center.

Another aspect of the present invention provides a system for providing mobile vehicle sales recommendations. The system comprises means for receiving vehicle usage data for at least one mobile vehicle at a call center, means for creating at least one vehicle usage profile based on the received vehicle usage data, means for receiving a vehicle profile request at the call center from a sales center, and means for sending the vehicle usage profile based on the received vehicle profile request from the call center to the sales center.

A third aspect of the present invention provides a computer readable medium storing a computer program including computer readable code for providing mobile vehicle sales recommendations. The computer readable medium comprises: computer program code for receiving vehicle usage data for at least one mobile vehicle at a call center, computer program code for creating at least one vehicle usage profile based on the received vehicle usage data, computer program code for receiving a vehicle profile request at the call center from a sales center, and computer program code for sending the vehicle usage profile based on the received vehicle profile request from the call center to the sales center.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of one embodiment a system for providing mobile vehicle sales recommendations in accordance with the present invention;

FIG. 2 is a flowchart representative of one embodiment of a method for providing mobile vehicle sales recommendations in accordance with the present invention;

FIG. 3 is a flowchart illustrating one embodiment of a method 300 of creating at least one vehicle usage profile (step 220 of FIG. 2), in accordance with the present invention; and

FIG. 4 is a flowchart illustrating another embodiment of a method 400 of creating at least one vehicle usage profile (step 220 of FIG. 2), in accordance with the present invention.

### DETAILED DESCRIPTION OF THE PRESENTLY PREFERRED EMBODIMENTS

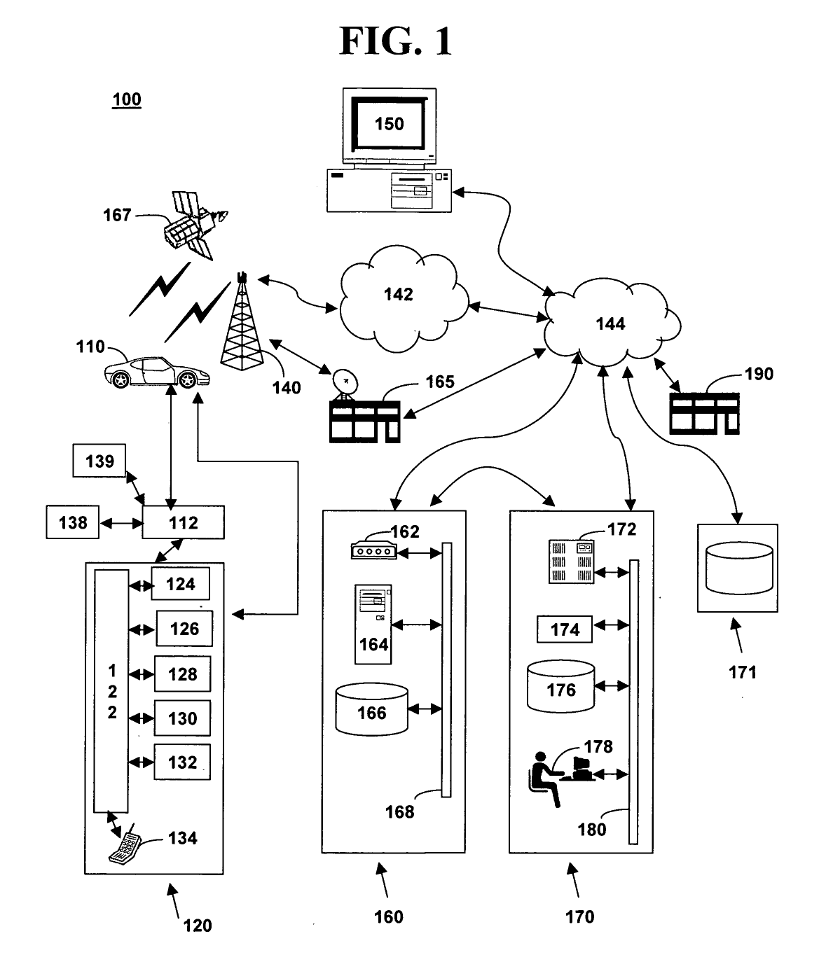

FIG. 1 illustrates one embodiment of a system for communications between a telematics call center and a telematics unit, in accordance with the present invention at 100. The communication system includes a mobile vehicle communication unit (MVCU) 110, a vehicle communication network 112, a telematics unit 120, one or more wireless carrier systems 140, one or more communication networks 142, one or more land networks 144, one or more client, personal, or user computers 150, one or more web-hosting portals 160, and one or more call centers 170. In one embodiment, MVCU 110 is implemented as a mobile vehicle equipped with suitable hardware and software for transmitting and receiving voice and data communications. A display may be embedded in MVCU 110. The display may be a dialed digital display such as a radio unit or an instrument panel. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, data transfers from telematics, and calling from telematics unit 120. Vehicle communication network 112 connects various vehicle electronic modules 138 and sensors 139 with telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, GPS unit 126 or speakers 132. Telematics unit 120 may include additional components not relevant to the present discussion.

In one embodiment, processor 122 is implemented as a microcontroller, microprocessor, controller, host processor, or vehicle communications processor. In an example, processor 122 is implemented as an application-specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g., call signals) between telematics unit 120, wireless carrier system 140, and call center 170. In one embodiment, a voice-recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from processor 122 are translated into voice messages and sent out through speaker 132.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, satellite uplink facility 165, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160, call center 170, and satellite uplink facility 165.

Client, personal, or user computer 150 includes a computer usable medium to execute Internet browser and Internet-access computer programs for sending and receiving data over land network 144 and, optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations, and theft alarm settings. For each client, the web server potentially stores hundreds of preferences for wireless vehicle communication, networking, maintenance and diagnostic services for a mobile vehicle 110.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle 110. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicates with telematics unit 120 in MVCU 110 through wireless carrier system 140, communication network 142, land network 144 and web hosting portals 160 using voice or data transmissions. In an alternative embodiment, communication services manager 174 communicates with telematics unit 120 in MVCU 110 through wireless carrier system 140, communication network 142, land network 144, and web hosting portals 160 using voice or data transmissions. Switch 172 selects between voice transmissions and data transmissions.

Vehicle usage data is collected from various electronic modules 138 and sensors 139 within MVCU 110 by telematics unit 120. In one embodiment, telematics unit 120 stores vehicle usage data for transmission to call center 170 at a designated time. A designated time is based on either a predetermined time interval stored in telematics unit 120 or the occurrence of a predefined transmittal trigger. In another embodiment, call center 170 initiates transmission of vehicle usage data from the telematics unit 120 to the call center 170.

Call center 170 receives, via network system 180, vehicle usage data from MVCU 110 and stores the vehicle usage data in communication services database 176. Communications service manager 174 receives vehicle profile requests from and sends vehicle usage profiles to various sales centers 190. In one embodiment, vehicle usage data in transmitted from call center 170 to third party data center 171.

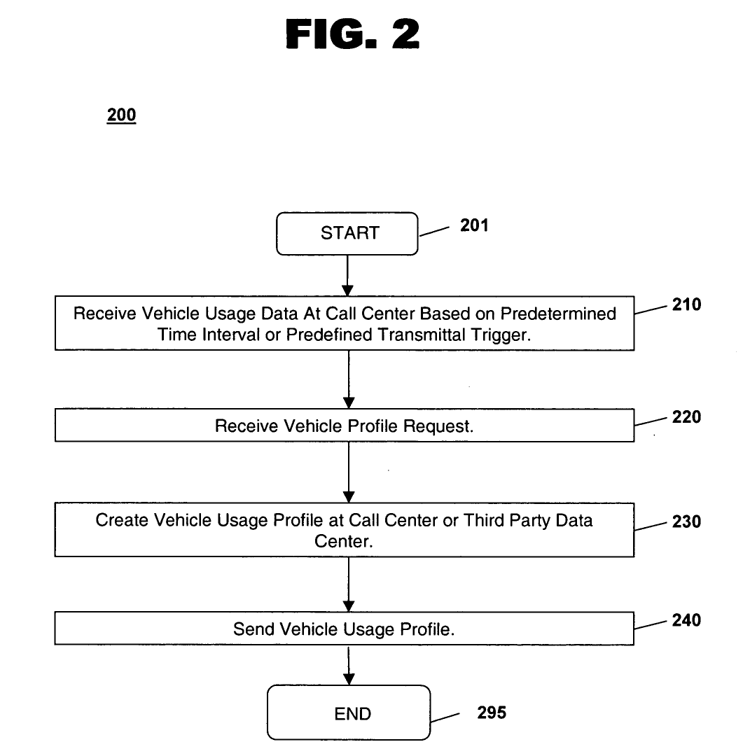

FIG. 2 is a flowchart illustrating one embodiment of a method 200 for providing mobile vehicle 110 sale recommendations, in accordance with the present invention. Method 200 begins at 201. The mobile vehicle 110 sales recommendation method provides a vehicle usage profile available, on request, to a sales representative at a sales center 190. The vehicle usage profile contains data about a subscriber's current mobile vehicle 110. A subscriber's experience with their current mobile vehicle 110 is useful in assisting them in choosing a new vehicle and in selecting options to include in the new vehicle. The vehicle usage profile provides an overview of the subscriber's previous experience through a collection of vehicle usage data. Both the subscriber and the sales representative can use the vehicle usage profile in determining the best vehicle choice for the subscriber.

During step 210, vehicle usage data is received for at least one mobile vehicle 110 at a call center 170. Vehicle usage data is information related to the operation of the mobile vehicle 110 by an operator and information regarding the environment in which the mobile vehicle 110 is operated. Examples of vehicle usage data include mileage, fuel usage, operating hours, battery life, oil life, engine wear, location, entertainment system usage, demographic data, ambient temperature, and ignition codes. For example, entertainment system usage data includes data relating to entertainment enjoyed by a user, volume of the entertainment system, time of entertainment enjoyment, frequency of entertainment subsystem usage, tracking CDDB codes for musical compositions, status of radio presets, and the like. In one embodiment, demographic data includes age, family status, number of drivers, and other demographic data tracked by a service provider. The vehicle usage data is determined from various sensors and vehicle electronic modules within the vehicle. The vehicle usage data is a series of data points, an average of those data points or a cumulative total of the data points over a predefined time interval. An example of a series of data points is all of the ignition codes that occur within a specified time interval. An example of an average reading is an average ambient temperature over the specified time interval. In another example, a series of data points includes titles of all prerecorded entertainment played over the entertainment system subcomponents. An entertainment system subcomponent includes CD players, DVD players, rear seat entertainment devices, satellite radio, and the like. The miles traveled during a specified time interval are an example of a cumulative total. Vehicle usage data is stored in in-vehicle memory of the mobile vehicle's 110 telematics unit 120 until the data is transmitted to call center 170.

The vehicle usage data is received at call center 170 based on a predetermined time interval or based on a predefined transmittal trigger. In one embodiment, the predefined time interval is determined by the call center 170. In another embodiment, a third party determines the predefined time interval. The call center 170 connects to the telematics unit 120 at the specified time and retrieves the vehicle usage data stored in the telematics unit of the mobile vehicle 110. The predefined transmittal trigger is defined and stored in the telematics unit. Upon occurrence of a trigger event specified in the predetermined transmittal trigger, the telematics unit 120 initiates a data call to a call center 170 and transmits the vehicle usage data stored in the telematics unit 120 to the call center 170. Examples of predetermined transmittal triggers include a day of the week, a number of ignition events, or a mileage interval.

In one embodiment, the vehicle usage data is sent from the call center to a third party data center 171. In one embodiment, third party data center 171 is a facility contracted to manage the vehicle usage data for the call center 170.

During step 220, a vehicle profile request is received at a call center 170 from a sales center 190. When a subscriber engages a sales representative in specifying a vehicle, the sales representative or the subscriber can initiate a request for a vehicle usage profile. The vehicle usage profile is a compilation of the vehicle usage data in a human readable format and includes sales recommendations based on the vehicle usage data collected. In one embodiment, the vehicle usage profile includes only the compiled data without the sales recommendations. In another embodiment, where the vehicle usage data has been sent to the third party data center 171, the vehicle usage profile is created at the third party data center 171. The vehicle usage profile provides a vehicle sales person or the owner with information useful for selecting a new vehicle. A sales center 190 interface is provided at the sales center 190 for generating the vehicle profile request. In one embodiment, the sales center 190 interface can be a computer interface with direct access to the call center database storing the vehicle usage profile. In another embodiment the sales center 190 interface is a computer interface that generates a request for the call center to send the vehicle usage profile. The call center 170 can send the vehicle usage profile various methods including fax and email. In another embodiment, the sales center 190 interface is a telephone voice interface whereby the vehicle profile request is generated by pressing phone keys in response to voice prompts. In another embodiment, the vehicle profile request is generated by interactive voice recognition tools. Third party data center 171, in one embodiment, is accessible to a user via telephone contact, web interface, in person visit or other customer interaction methods.

During step 230, at least one vehicle usage profile is created based on the received vehicle usage data. In one embodiment, the vehicle usage profile is created when the vehicle profile request is received at the call center 170 from the sales center 190. In another embodiment, the vehicle usage profile is created based on another trigger event, such as a service request from the subscriber.

During step 240, the vehicle usage profile is sent from the call center 170 to the sales center 190 based on the received vehicle profile request. The call center 170 sends the vehicle usage profile to the sales center 190 via fax, email, or network transfer. Once the vehicle usage profile is received, the sales representative and the subscriber can use the information in the vehicle usage profile to assist in selecting a new vehicle and in selecting the options to include with the vehicle. The vehicle usage profile includes sales recommendations to further assist the parties in selecting the vehicle. In one embodiment, upon request by the call center 170, the third party data center 171 sends the vehicle usage profile to the sales center 190.

Method 200 ends at step 295.

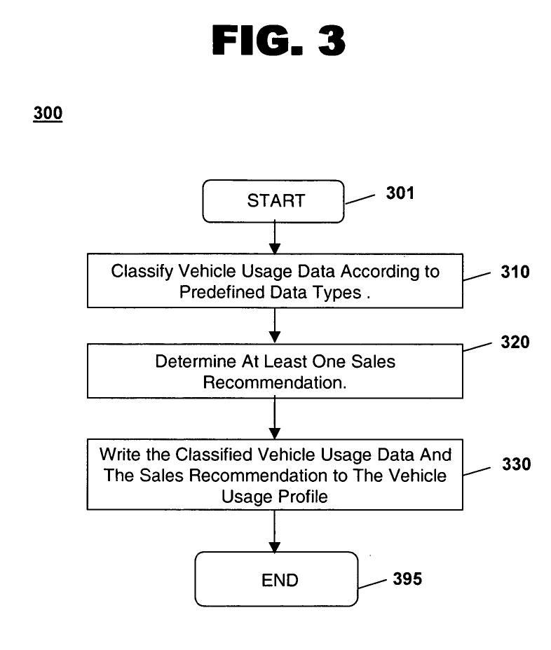

FIG. 3 is a flowchart illustrating one embodiment of a method 300 of creating at least one vehicle usage profile (step 220 of FIG. 2), in accordance with the present invention. Method 300 begins at 301.

During step 310, the vehicle usage data is classified according to a plurality of predefined data types. Various types of vehicle usage data can be combined under a data type to simplify how the data is presented to the end user and to assist in providing sales recommendation based on the data. For example, fuel usage, miles driven and hours operated can be combined under a data type defined as “suggested vehicle model”. Another data type defined as “comfort features” can include hours operated and miles driven. A single type of vehicle usage data can be included under more than one data-type.

During step 320, a sales recommendation is determined for each predefined data type from step 310. The sales recommendation is determined from a sales knowledge database. The sales knowledge database includes logic that reads the vehicle usage data values in each data type and selects at least one sales recommendation based on the those values. For example, using the suggested vehicle model data-type from step 310, if the values of each of the three types of vehicle usage data included in this data-type are high, the sales knowledge database can associate a sales recommendation for a fuel-efficient vehicle to reduce future fuel costs. In another example, comfort options such as power seats, power steering, or upgraded climate control can be recommended for subscribers that spend a large number of hours in their vehicle and/or drive a significant distance in a short period of time.

During step 330, the classified vehicle data and the determined sales recommendation are written to the vehicle usage profile. The vehicle usage profile is stored at the call center or at the third party data center until a request for the vehicle usage profile is received from the sales center 190.

Method 300 ends at step 395.

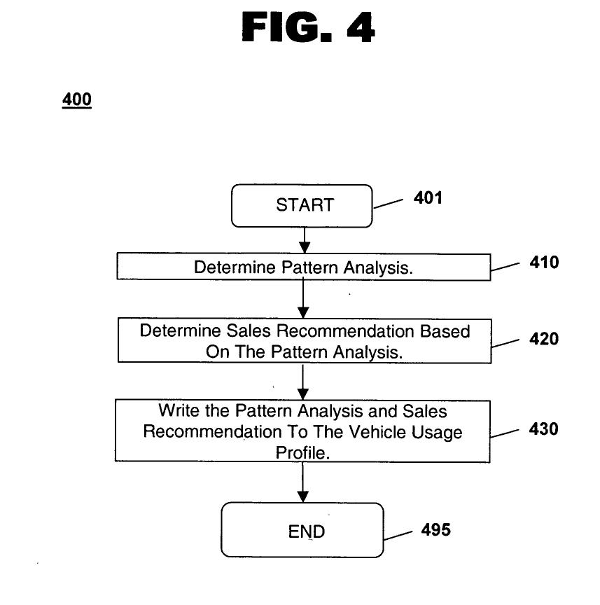

FIG. 4 is a flowchart illustrating another embodiment of a method 400 of creating at least one vehicle usage profile (step 220 of FIG. 2), in accordance with the present invention. Method 400 begins at 401.

During step 410, a pattern analysis is determined based on a plurality of vehicle usage data received over a period of time. Certain sales recommendations can be based on patterns of data. The pattern analysis is a determination of the trend the data follows over a predefined time period. An example of a pattern analysis is the ambient temperature versus miles driven over a year.

During step 420, at least one sales recommendation is determined based on the pattern analysis determined in step 410. In the example of the pattern analysis for temperature versus miles driven over a years time, if the majority of the miles are driven during a cold season a cold weather start package can be recommended.

During step 430 the pattern analysis and the determined sales recommendation are written to the vehicle usage profile.

Method 400 ends at step 495.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for providing mobile vehicle sales recommendations, the method comprising:
receiving vehicle usage data for at least one mobile vehicle at a call center;
creating at least one vehicle usage profile based on the received vehicle usage data;
receiving a vehicle profile request at the call center from a sales center; and
sending the vehicle usage profile based on the received vehicle profile request from the call center to the sales center.

2. The method of claim 1 wherein creating at least one vehicle usage profile based on the received vehicle usage data comprises:
classifying the vehicle usage data according to a plurality of predefined data types;
determining at least one sales recommendation for each predefined data type;
writing the classified vehicle usage data with the determined sales recommendation to the vehicle usage profile; and
saving the vehicle usage profile to a storage system at one of a call center and a third party data center.

3. The method of claim 1 wherein creating at least one vehicle usage profile based on the received vehicle usage data comprises:
determining a pattern analysis based on a plurality of vehicle usage data received over a predetermined time period;
determining at least one sales recommendation based on the determined pattern analysis; and
writing the pattern analysis and the sales recommendation to the vehicle usage profile.

4. The method of claim 1 wherein the vehicle usage data is received at the call center based on a predetermined time interval.

5. The method of claim 1 wherein the vehicle usage data is received at the call center based on a predefined transmittal trigger.

6. The method of claim 1 wherein the vehicle usage data is sent from the call center to a third party data center.

7. The method of claim 1 wherein the vehicle usage profile is created at a third party data center.

8. The method of claim 1 further comprising:
providing a sales center interface wherein the vehicle usage profile request is generated at the sales center using the sales center interface.

9. The method of claim 1 wherein the vehicle usage data is selected from the group consisting of mileage, fuel usage, operating hours, oil life, engine wear, location, entertainment system usage, battery life, ambient temperature, and ignition codes.

10. The method of claim 2 wherein determining at least one sales recommendation comprises:
comparing the vehicle usage data to a sales knowledge database; and
selecting at least one sales recommendation from the sales knowledge database.

11. A system for providing mobile vehicle sales recommendations, the system comprising:
means for receiving vehicle usage data for at least one mobile vehicle at a call center;
means for creating at least one vehicle usage profile based on the received vehicle usage data;
means for receiving a vehicle profile request at the call center from a sales center; and
means for sending the vehicle usage profile based on the received vehicle profile request from the call center to the sales center.

12. The system of claim 11 wherein creating at least one vehicle usage profile based on the received vehicle usage data comprises:
means for classifying the vehicle usage data according to a plurality of predefined data types;
means for determining at least one sales recommendation for each predefined data type;
means for writing the classified vehicle usage data with the determined sales recommendation to the vehicle usage profile; and
means for saving the vehicle usage profile to a storage system at one of a call center and a third party data center.

13. The system of claim 11 wherein creating at least one vehicle usage profile based on the received vehicle usage data comprises:
means for determining a pattern analysis based on a plurality of vehicle usage data received over a predetermined time period;
means for determining at least one sales recommendation based on the determined pattern analysis; and
means for writing the pattern analysis and the sales recommendation to the vehicle usage profile.

14. The system of claim 11 further comprising:
means for providing a sales center interface wherein the vehicle usage profile request is generated at the sales center using the sales center interface.

15. The system of claim 12 wherein determining at least one sales recommendation comprises:
means for comparing the vehicle usage data to a sales knowledge database; and
means for selecting at least one sales recommendation from the sales knowledge database.

16. A computer readable medium storing a computer program including computer program code for providing mobile vehicle sales recommendations, the computer usable medium comprising:
computer program code for receiving vehicle usage data for at least one mobile vehicle at a call center;
computer program code for creating at least one vehicle usage profile based on the received vehicle usage data;
computer program code for receiving a vehicle profile request at the call center from a sales center; and
computer program code for sending the vehicle usage profile based on the received vehicle profile request from the call center to the sales center.

17. The computer usable medium of claim 16 wherein computer program code for creating at least one vehicle usage profile based on the received vehicle usage data comprises:
computer program code for classifying the vehicle usage data according to a plurality of predefined data types;
computer program code for determining at least one sales recommendation for each predefined data type;
computer program code for writing the classified vehicle usage data with the determined sales recommendation to the vehicle usage profile; and
computer program code for saving the vehicle usage profile to a storage system at one of a call center and a third party data center.

18. The computer usable medium of claim 16 wherein computer program code for creating at least one vehicle usage profile based on the received vehicle usage data comprises:
computer program code for determining a pattern analysis based on a plurality of vehicle usage data received over a predetermined time period;
computer program code for determining at least one sales recommendation based on the determined pattern analysis; and
computer program code for writing the pattern analysis and the sales recommendation to the vehicle usage profile.

19. The computer usable medium of claim 16 further comprising:
computer program code for providing a sales center interface wherein the vehicle usage profile request is generated at the sales center using the sales center interface.

20. The computer usable medium of claim 17 wherein computer program code for determining at least one sales recommendation comprises:
computer program code for comparing the vehicle usage data to a sales knowledge database; and
computer program code for selecting at least one sales recommendation from the sales knowledge database.
